(19) United States
(12) Patent Application Publication
(10) Pub. No.: US 2014/0234666 A1
(43) Pub. Date: Aug. 21, 2014

(54) LUBRICANTS COMPRISING PFPE TERMINATED WITH BENZENE OR FUNCTIONAL BENZENE END GROUPS FOR MAGNETIC RECORDING MEDIA STRUCTURE

(71) Applicant: WD Media, Inc., (US)

(72) Inventors: BERNHARD E. KNIGGE, SAN JOSE, CA (US); MOUSUMI MANI BISWAS, CUPERTINO, CA (US)

(73) Assignee: WD MEDIA, INC., San Jose, CA (US)

(21) Appl. No.: 13/770,948

(22) Filed: Feb. 19, 2013

(51) Int. Cl. G11B 5/725

(52) U.S. Cl. CPC G11B 5/725
USPC 428/833.3; 428/833; 427/127; 568/615

(57) ABSTRACT

A novel lubricant comprising a perfluoropoyether (PFPE) molecule terminated with a benzene molecule or a functional benzene molecule for a magnetic recording media structure is disclosed. The magnetic recording media structure includes a substrate, a magnetic recording layer for recording information disposed over the substrate, a protective overcoat layer for protecting the magnetic recording layer disposed over the magnetic recording layer, and a lubricant layer disposed over the protective overcoat layer and comprising a perfluoropoyether (PFPE) molecule terminated with a benzene molecule or a functional benzene molecule.

### FIELD OF THE INVENTION

The present invention generally relates to lubricants for magnetic recording media and, in particular, relates to lubricants comprising perfluoropoyether (PFPE) terminated with benzene or functional benzene end groups for magnetic recording media structure.

### BACKGROUND

Conventional lubricants used for magnetic recording media applications, such as Tetroal, have problems associated with the presence of -OH end groups. These problems include clustering due to interactions between end groups, a thicker lube layer due to formation of inverted U-shaped structures, thermal decomposition at high temperature, and lube mogul formation due to high mobility and clustering.

Some of these problems associated with conventional lubricants are illustrated in FIGS. 1 and 2. For example, FIG. 1 illustrates the end-group clustering problem due to interactions between —OH end groups and the normal lubricant layer thickness. FIG. 2 illustrates formation of inverted U-shaped structures resulting from the attachment of the end groups on the COC surface. Additionally, for an HAMR (Heat Assisted Magnetic Recording) system, in which the recording takes place at an elevated temperature, the surface adhesion may decrease, resulting in increases in lube mobility, lube mogul formation and lube decomposition. All of these problems contribute to a reduced reliability and performance for the hard disk drive (HDD).

### BRIEF SUMMARY OF THE SUBJECT DISCLOSURE

In some aspects, the above-identified problems associated with the conventional lubricants may be eliminated or reduced by the use of perfluoropoyether (PFPE) terminated with benzene or functional benzene end groups as lubricants for magnetic recording media applications.

In certain aspects, a magnetic recording media structure is provided. The magnetic recording media structure includes a substrate, a magnetic recording layer for recording information disposed over the substrate, a protective overcoat layer for protecting the magnetic recording layer disposed over the magnetic recording layer, and a lubricant layer disposed over the protective overcoat layer and comprising a perfluoropoyether (PFPE) molecule terminated with a benzene molecule or a functional benzene molecule.

In certain aspects, a method of lubricating a hard disk drive is provided. The method includes providing a magnetic recording media stack comprising a magnetic recording layer for recording information and a protective overcoat layer disposed over the magnetic recording layer, and providing a lubricant layer disposed over the protective overcoat layer and comprising a perfluoropoyether (PFPE) molecule terminated with a benzene molecule or a functional benzene molecule.

In certain aspects, a lubricant for a magnetic recording media structure comprising a perfluoropoyether (PFPE) molecule terminated with a benzene molecule or a functional benzene molecule is provided.

### BRIEF DESCRIPTION OF SEVERAL VIEWS OF THE DRAWINGS

FIG. 1 is a diagram illustrating the end-group clustering problem due to interactions between —OH end groups associated with conventional lubricants and the normal lubricant layer thickness.

FIG. 2 is a diagram illustrating formation of inverted U-shaped structures resulting from the attachment of the end groups on the COC surface associated with conventional lubricants.

FIG. 3 is a diagram depicting a HDD system comprising a magnetic recording media stack (“disk”) and a magnetic read/write head (“head”) according to certain aspects of the subject disclosure.

FIG. 4 is a diagram depicting one benzene-terminated perfluoropoyether (PFPE) molecule that can be used as lubricant in the magnetic recording media stack shown in FIG. 1 according to certain aspects of the subject disclosure.

FIG. 5A is a diagram depicting a cross-sectional view of a disk with benzene-terminated PFPE lubricant and a head according to certain aspects of the subject disclosure.

FIG. 5B is a diagram depicting a perspective view of a disk with benzene-terminated PFPE lubricant and a head according to certain aspects of the subject disclosure.

### DETAILED DESCRIPTION

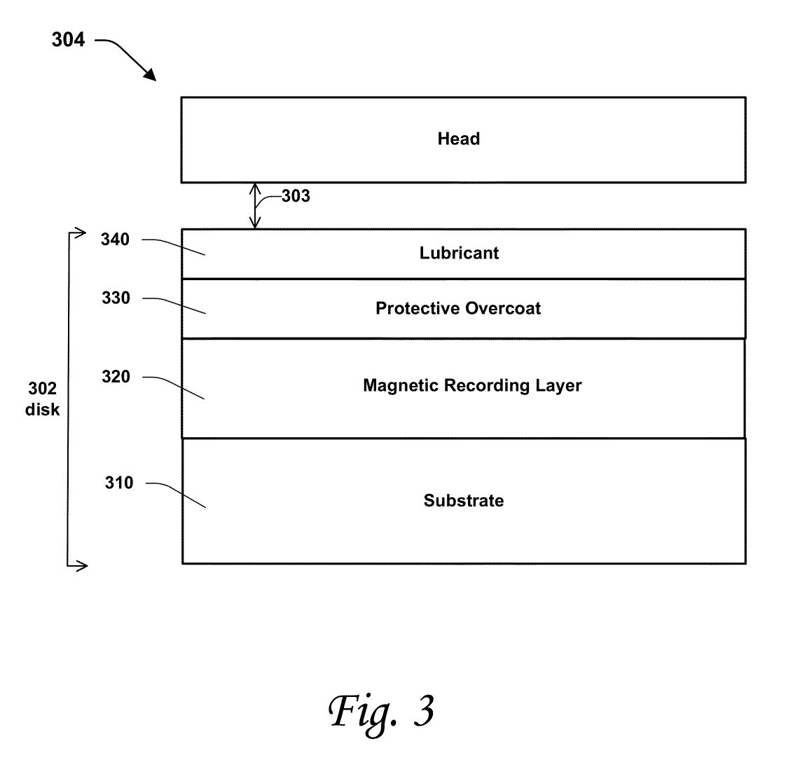

FIG. 3 is a diagram depicting a HDD system 300 comprising a magnetic recording media stack (“disk”) 302 and a magnetic read/write head (“head”) 304. The head 304 is disposed above the disk 302 and separated from each other by a head-media spacing 303. The magnetic recording media stack 302 includes a substrate 310, a magnetic recording layer 320 for recording information, a protective overcoat 130 for protecting the magnetic recording layer 320, and lubricant 340 for lubricating the protecting overcoat 130. The lubricant 340 is designed to prevent a catastrophic crash when the head 304 comes in contact with the disk 302. In certain embodiments, the protective overcoat layer 330 is carbon overcoat (COC) and has a thickness between about 0.5 and 4 nm.

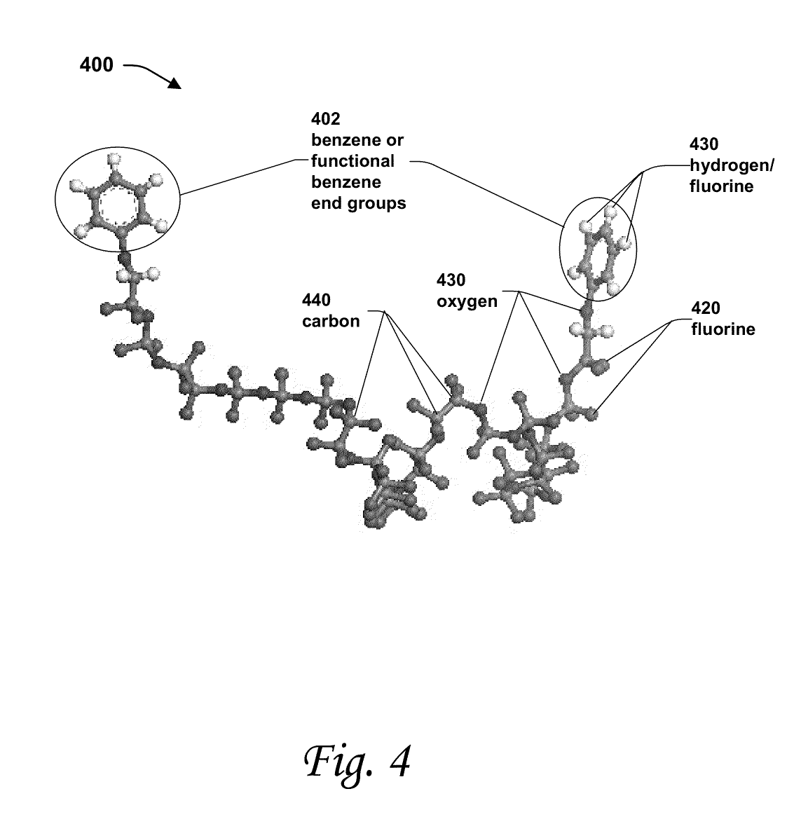

FIG. 4 is a diagram depicting one benzene-terminated perfluoropoyether (PFPE) molecule 400 that can be used as lubricant 340 in the magnetic recording media stack 302 shown in FIG. 3 according to certain aspects of the subject disclosure. The PFPE module 400 comprises carbon 420 and oxygen 430 and fluorine 440. In the illustrated embodiment, the PFPE molecule 400 is terminated at both ends with benzene rings having hydrogen atoms 430 attached thereto. In some embodiments, the PFPE molecule 400 is terminated with functional benzene rings with one or more hydrogen atoms 430 replaced with F, CH3, NH2, OH, or CF3. In one particular embodiment, the PFPE molecule 400 is terminated with fluorinated benzene molecules terminated at both ends. In certain embodiments, the PFPE module 400 is terminated only at one end with a benzene or functional benzene molecule. In some embodiments, the PFPE molecule 400 is terminated at both ends with benzene or functional benzene rings and there is an additional benzene molecule or a functional benzene molecule attached to the backbone of the PFPE molecule at an intermediate location (multi-dentate).

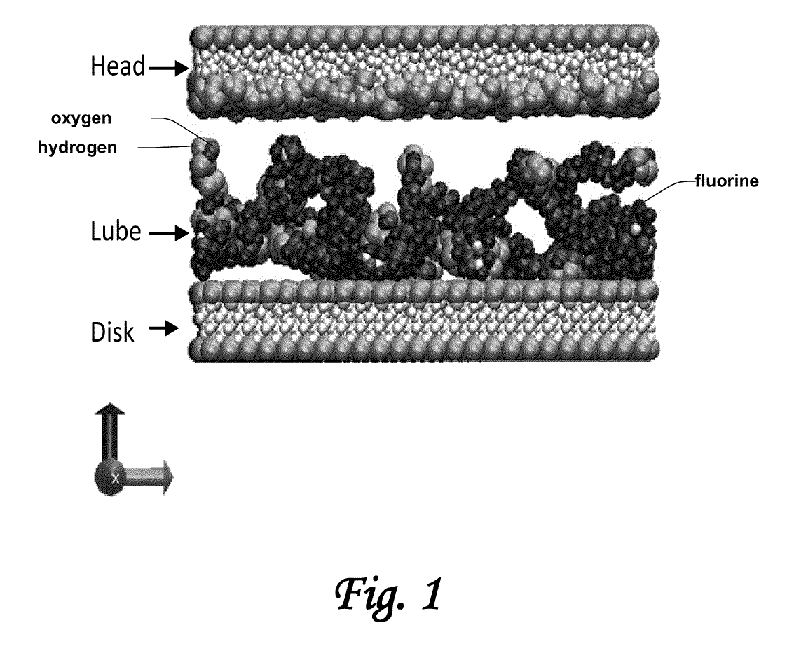

Compared to conventional PFPE (Tetroal) with hydroxyl (—OH) end groups, PFPE molecules terminated with benzene or functional benzene end groups improves the surface adhesion to the protective overcoat (e.g., COC) layer 330 (FIG. 1). Due to the improved adhesion, replacing the conventional —OH containing end groups (molecular weight 74) with benzene (molecular weight 78) or fluorinated benzene improves the lubricant coverage, reduces clustering, produces a thinner lubrication layer or film 340 and reduces the head-media spacing 303.

Molecular dynamic simulations have been performed using LAMMPS (Large Scale Atomistic Molecular Massively Parallel Simulator, by Sandia National Lab). In the simulations, sixteen benzene-terminated PFPE (Tetraol) molecules (MW 2000 gm/mole) were placed on a COC (diamond like carbon) surface. The COC surface is nitrogenated (10%) and contains 2% surface —OH group. Each of the head 304 and the disk 302 included a COC having surface dimensions of about 85×85 angstroms and about 10 angstroms thick. The head COC is a hydrogenated DLC.

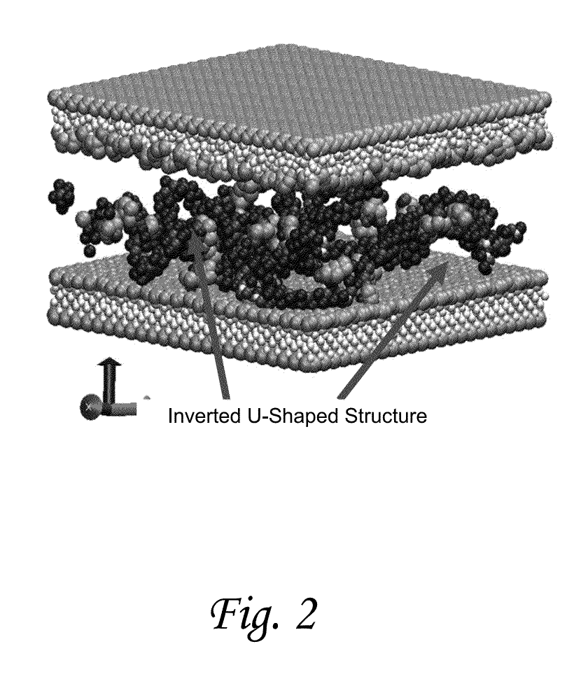

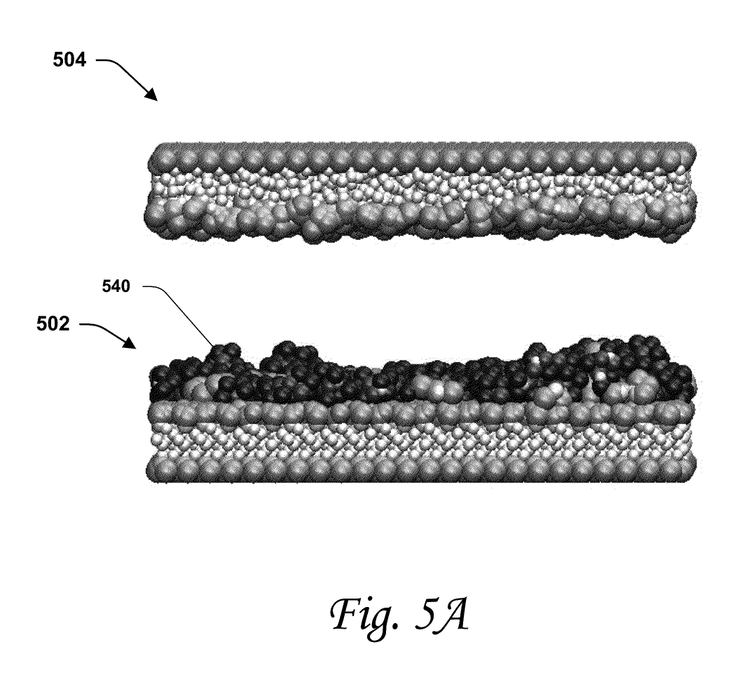

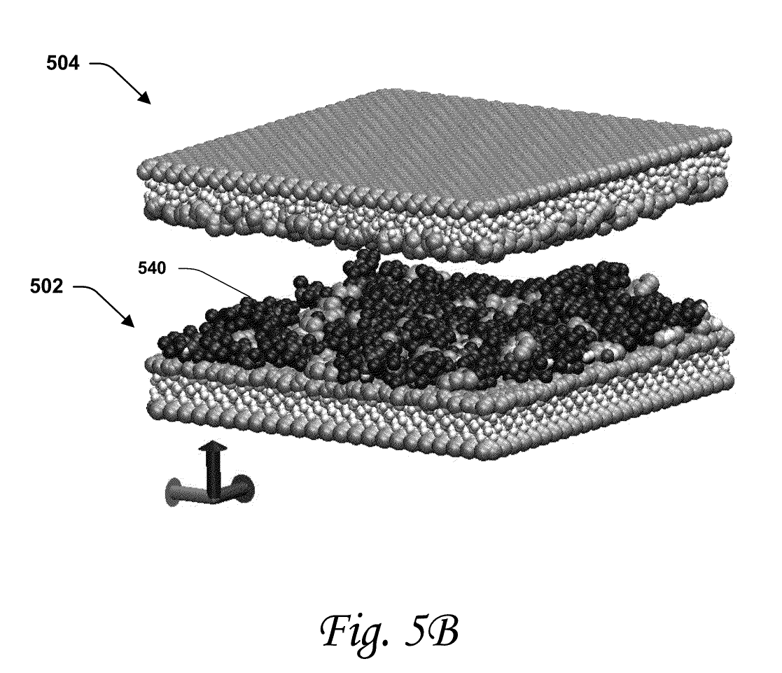

After equilibrating the benzene-terminated PFPE on such a COC disk surface for 500 ps simulation time, it was found that the molecules formed a uniform film on the COC surface with a better surface coverage compared to —OH-terminated Tetraol with similar molecular weight (FIGS. 1 and 2). FIG. 5A and FIG. 5B are diagrams depicting cross-sectional and perspective views, respectively, of a disk 502 with benzene-terminated PFPE lubricant 540 and a head 504 according to certain aspects of the subject disclosure.

The simulations demonstrate that benzene-terminated PFPE molecule provides a number of advantages compared to conventional lubricants. The advantages include an increased COC surface adhesion and reduced clustering. Additionally, due to absence of —OH end groups, lube clustering is reduced or eliminated. Furthermore, due to interaction of benzene rings with the COC surface, the benzene-terminated PFPE molecule provides a better surface adhesion resulting in a greater structural stability for the lubricant film.

The benzene-terminated PFPE molecule also forms a thinner film on the COC as compared to conventional lubricants such as Tetraol. In the simulations, a benzne-terminated PFPE film having a thickness of about 8 angstroms was obtained as compared to about 14 angstroms for Tetraol or other conventional lubes with similar molecular weight. As illustrated in FIG. 2, the conventional lubricants attach on the COC surface by the end group and form an inverted U shaped structure resulting in a thicker film and a higher head-media spacing. By contrast, as illustrated in FIGS. 5A and 5B, the benzene-terminated PFPE lubricant 540 tends to lie parallel to the COC surface resulting in a thinner film and a lower head-media spacing. In the illustrated example of FIGS. 5A and 5B, the thinner lubricant film (8 angstroms) resulted in the head-media spacing of 27 angstroms.

Interaction energy with the disk per benzene-terminated PFPE molecule is about −22.06 kcal/molecule (negative sign indicated more attractive nature, or as cohesive energy) compared to 68.98 kcal/molecule for similar molecular weight Tetraol. Thus, the benzene-terminated PFPE molecules have less mobility and lube clustering (lube mogul) is reduced under shear flow condition.

Accordingly, the use of PFPE molecules terminated with benzene or functional benzene molecules as lubricant in a magnetic recording media stack can reduce or eliminate many problems associated with conventional lubricants resulting in improved reliability and performance for the HDD. Similar benzene or functional benzene end groups may be used in other conventional lubricants to achieve better adhesion, surface coverage, thinner lube film, and reduced head media spacing.

The description of the invention is provided to enable any person skilled in the art to practice the various embodiments described herein. While the present invention has been particularly described with reference to the various figures and embodiments, it should be understood that these are for illustration purposes only and should not be taken as limiting the scope of the invention.

There may be many other ways to implement the invention. Various functions and elements described herein may be partitioned differently from those shown without departing from the spirit and scope of the invention. Various modifications to these embodiments will be readily apparent to those skilled in the art, and generic principles defined herein may be applied to other embodiments. Thus, many changes and modifications may be made to the invention, by one having ordinary skill in the art, without departing from the spirit and scope of the invention.

A reference to an element in the singular is not intended to mean “one and only one” unless specifically stated, but rather “one or more.” The term “some” refers to one or more. Underlined and/or italicized headings and subheadings are used for convenience only, do not limit the invention, and are not referred to in connection with the interpretation of the description of the invention. All structural and functional equivalents to the elements of the various embodiments of the invention described throughout this disclosure that are known or later come to be known to those of ordinary skill in the art are expressly incorporated herein by reference and intended to be encompassed by the invention. Moreover, nothing disclosed herein is intended to be dedicated to the public regardless of whether such disclosure is explicitly recited in the above description.

We claim:

1. A magnetic recording media structure comprising:
a substrate;
a magnetic recording layer for recording information disposed over the substrate;
a protective overcoat layer for protecting the magnetic recording layer disposed over the magnetic recording layer; and
a lubricant layer disposed over the protective overcoat layer and comprising a perfluoropoyether (PFPE) molecule terminated with a benzene molecule or a functional benzene molecule.

2. The magnetic recording media structure of claim 1, wherein the magnetic recording media structure is a heat assisted magnetic recording (HAMR) media structure.

3. The magnetic recording media structure of claim 1, wherein the protective overcoat layer has a thickness between about 0.5 and 4 nm.

4. The magnetic recording media structure of claim 1, wherein the lubricant layer has a thickness between about 0.5 and 3 nm.

5. The magnetic recording media structure of claim 1, wherein the protective overcoat layer comprises a carbon overcoat (COC).

6. The magnetic recording media structure of claim 1, wherein the functional benzene molecule is a benzene ring with one or more of its hydrogen atoms replaced with F, CH3, NH2, OH, or CF3.

7. The magnetic recording media structure of claim 1, wherein two end groups of the PFPE molecule are terminated with two benzene molecules or two functional benzene molecules.

8. The magnetic recording media structure of claim 7, wherein a benzene molecule or a functional benzene molecule is attached to the backbone of the PFPE molecule at an intermediate location.

9. A method of lubricating a hard disk drive, the method comprising:
providing a magnetic recording media stack comprising a magnetic recording layer for recording information and a protective overcoat layer disposed over the magnetic recording layer; and
providing a lubricant layer disposed over the protective overcoat layer and comprising a perfluoropoyether (PFPE) molecule terminated with a benzene molecule or a functional benzene molecule.

10. The method of claim 9, wherein the magnetic recording media stack is a heat assisted magnetic recording (HAMR) media stack.

11. The method of claim 9, wherein the protective overcoat layer comprises a carbon overcoat (COC).

12. The method of claim 9, wherein the functional benzene molecule is a benzene ring with one or more of its hydrogen atoms replaced with F, CH3, NH2, OH, or CF3.

13. The method of claim 9, wherein two end groups of the PFPE molecule are terminated with two benzene molecules or two functional benzene molecules.

14. The method of claim 13, wherein a benzene molecule or a functional benzene molecule is attached to the backbone of the PFPE molecule at an intermediate location.

15. A lubricant for a magnetic recording media structure comprising a perfluoropoyether (PFPE) molecule having at least one end group terminated with a benzene molecule or a functional benzene molecule.

16. The lubricant of claim 15, wherein the PFPE molecule is terminated with two benzene molecules or two functional benzene molecules.

17. The lubricant of claim 16, wherein a functional benzene molecule is attached to the backbone of the PFPE molecule at an intermediate location.
